(19) United States
(12) Patent Application Publication
(10) Pub. No.: US 2014/0160089 A1
(43) Pub. Date: Jun. 12, 2014

(54) INTERACTIVE INPUT SYSTEM AND INPUT TOOL THEREFOR

(71) Applicant: SMART TECHNOLOGIES ULC, Calgary (CA)

(72) Inventors: MARK FLETCHER, Calgary (CA); STEPHEN BOLT, Calgary (CA)

(73) Assignee: SMART TECHNOLOGIES ULC, Calgary (CA)

(21) Appl. No.: 13/712,076

(22) Filed: Dec. 12, 2012

(51) Int. Cl. G06F 3/033

(52) U.S. Cl. CPC G06F 3/033
USPC 345/179

(57) ABSTRACT

An input tool for use with an interactive input system comprises a body housing processing circuitry storing input tool operating mode data representing operating modes of the input tool and at least one display on the body and communicating with the processing circuitry. The display is responsive to the processing circuitry to present a selected operating mode of the input tool.

### FIELD OF THE INVENTION

The present invention relates to an interactive input system and to an input tool therefor.

### BACKGROUND OF THE INVENTION

Interactive input systems that allow users to input ink into an application program using an active pointer (e.g. a pointer that emits light, sound or other signal), a passive pointer (e.g. a finger, cylinder or other object) or other suitable input device such as for example, a mouse or trackball, are well known. These interactive input systems include but are not limited to: touch systems comprising touch panels employing analog resistive or machine vision technology to register pointer input such as those disclosed in U.S. Pat. Nos. 5,448,263; 6,141,000; 6,337,681; 6,747,636; 6,803,906; 7,232,986; 7,236,162; and 7,274,356 and in U.S. Patent Application Publication No. 2004/0179001 assigned to SMART Technologies ULC of Calgary, Alberta, Canada, assignee of the subject application, the disclosures of which are incorporated by reference in their entireties; touch systems comprising touch panels employing electromagnetic, capacitive, acoustic or other technologies to register pointer input; tablet and laptop personal computers (PCs); smartphones, personal digital assistants (PDAs) and other handheld devices; and other similar devices.

Above-incorporated U.S. Pat. No. 6,803,906 to Morrison et al. discloses a touch system that employs machine vision to detect pointer interaction with a touch surface on which a computer-generated image is presented. A rectangular bezel or frame surrounds the touch surface and supports digital imaging devices at its corners. The digital imaging devices have overlapping fields of view that encompass and look generally across the touch surface. The digital imaging devices acquire images looking across the touch surface from different vantages and generate image data. Image data acquired by the digital imaging devices is processed by on-board digital signal processors to determine if a pointer exists in the captured image data. When it is determined that a pointer exists in the captured image data, the digital signal processors convey pointer characteristic data to a master controller, which in turn processes the pointer characteristic data to determine the location of the pointer in (x,y) coordinates relative to the touch surface using triangulation. The pointer coordinates are conveyed to a computer executing one or more application programs. The computer uses the pointer coordinates to update the computer-generated image that is presented on the touch surface. Pointer contacts on the touch surface can therefore be recorded as writing or drawing or used to control execution of application programs executed by the computer.

U.S. Pat. No. 7,532,206 to Morrison et al. discloses a touch system that comprises a touch surface and at least one camera acquiring images of the touch surface. A pointer contact data generator generates pointer position data in response to pointer contact with the touch surface, the pointer position data representing where on the touch surface pointer contact is made. A processor communicates with the at least one camera and the pointer contact data generator. The processor analyzes acquired images to determine the type of pointer used to contact the touch surface, and processes the pointer position data in accordance with the determined type of pointer. In one embodiment, the processor distinguishes between pointer tip touch surface contacts, pointer backend touch surface contacts and finger touch surface contacts. A writing function is invoked in response to pointer tip touch surface contacts. An erase function is invoked in response to pointer backend touch surface contacts. Mouse events are generated in response to finger touch surface contacts.

U.S. Pat. No. 7,202,860 to Ogawa discloses a coordinate input device that includes a pair of cameras positioned in upper left and upper right positions of a display screen of a monitor lying close to a plane extending from the display screen of the monitor, and views both a side face of an object in contact with a position on the display screen and a predetermined desk-top coordinate detection area to capture an image of the object within the field of view. The coordinate input device also includes a control circuit which calculates a coordinate value of a pointing tool, pointing to a position within a coordinate detection field, based on video signals output from the pair of cameras, and transfers the coordinate value to a program of a computer.

Although the above-described interactive input systems are satisfactory, improvements are desired. It is therefore an object at least to provide a novel interactive input system, and a novel input tool therefor.

### SUMMARY OF THE INVENTION

Accordingly, in one aspect there is provided an input tool for use with an interactive input system, the input tool comprising a body housing processing circuitry storing input tool operating mode data representing operating modes of said input tool; and at least one display on the body and communicating with said processing circuitry, said display being responsive to said processing circuitry to present a selected operating mode of said input tool.

In one embodiment, the processing circuitry is responsive to user input to select one of the input tool operating modes for presentation on the display. The input tool operating modes may be grouped into categories with the operating modes of a user selected category being selectable for presentation on the display.

In one embodiment, at least one manually actuable element is provided on the housing. The processing circuitry is responsive to actuation of the at least one element to enable user selection of an input tool operating mode.

In one embodiment, the processing circuitry wirelessly broadcasts the selected input tool operating mode. In one form, the selected input tool operating mode may be used to modulate a signal broadcast by the processing circuitry. The display in one form is configured to display textual and graphical information and may present a graphical image icon of the selected input tool operating mode. The graphical image icon may generally correspond to an appearance of digital ink associated with the selected input tool operating mode.

According to another aspect there is provided an input tool for use with an interactive input system, the input tool comprising a pair of arms rotatably connected together by a hinge; a sensor providing output representing the angle formed between said arms; and processing circuitry communicating with said sensor and outputting a signal comprising angle information.

In one embodiment, the sensor comprises a potentiometer. The processing circuitry wirelessly broadcasts the signal and the angle information may be used to modulate the broadcast signal.

According to another aspect there is provided an input tool for use with an interactive input system, the input tool comprising an elongate body; and a deformable nib at one end of said body configured to contact an interactive surface.

In one embodiment, the deformable nib is generally conical and wherein the shape of the deformable nib becomes less conical and more cylindrical as pressure applied to the interactive surface by the deformable nib increases. The deformable nib may be fabricated of visco-elastic polyurethane foam that is coated with a polytetrafluoroethylene-based material.

According to another aspect there is provided an interactive input system comprising at least one imaging assembly capturing image frames of a region of interest; and processing structure communicating with said at least one imaging assembly and processing said captured image frames to determine the shape of an input tool tip appearing therein; and generate tip pressure data based on the determined shape of said input tool tip.

### BRIEF DESCRIPTION OF THE DRAWINGS

Embodiments will now be described more fully with reference to the accompanying drawings in which:

FIG. 1 is a schematic, partial perspective view of an interactive input system;

FIG. 2 is a block diagram of the interactive input system of FIG. 1;

FIG. 3 is a block diagram of an imaging assembly forming part of the interactive input system of FIG. 1;

FIGS. 4A and 4B are front and rear perspective views, respectively, of a housing assembly forming part of the imaging assembly of FIG. 3;

FIG. 5 is a block diagram of a master controller forming part of the interactive input system of FIG. 1;

FIGS. 6A and 6B are side elevational and top plan views, respectively, of an input tool for use with the interactive input system of FIG. 1;

FIG. 7 is a block diagram of the input tool of FIGS. 6A and 6B;

FIGS. 8A to 8C are side elevational views of the input tool of FIGS. 6A and 6B, showing different operating modes presented on a display thereof;

FIG. 9 is a side elevational view of an alternative input tool for use with the interactive input system of FIG. 1;

FIG. 10 is a block diagram of the input tool of FIG. 9;

FIG. 11 is a side elevational view of another alternative input tool for use with the interactive input system of FIG. 1;

FIGS. 12A to 12D are side elevational views of the input tool of FIG. 11, showing deformation of the input tool tip in response to applied pressure; and

FIG. 13 is a front view of an interactive surface of the interactive input system of FIG. 1, displaying digital ink input using the input tool of FIG. 11.

### DETAILED DESCRIPTION OF THE EMBODIMENTS

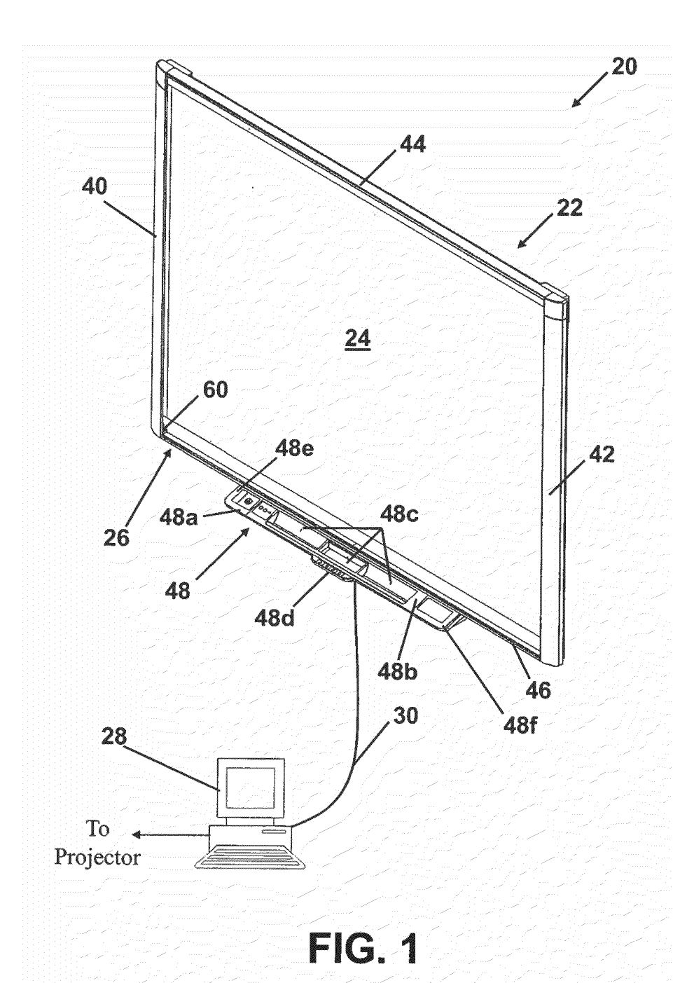

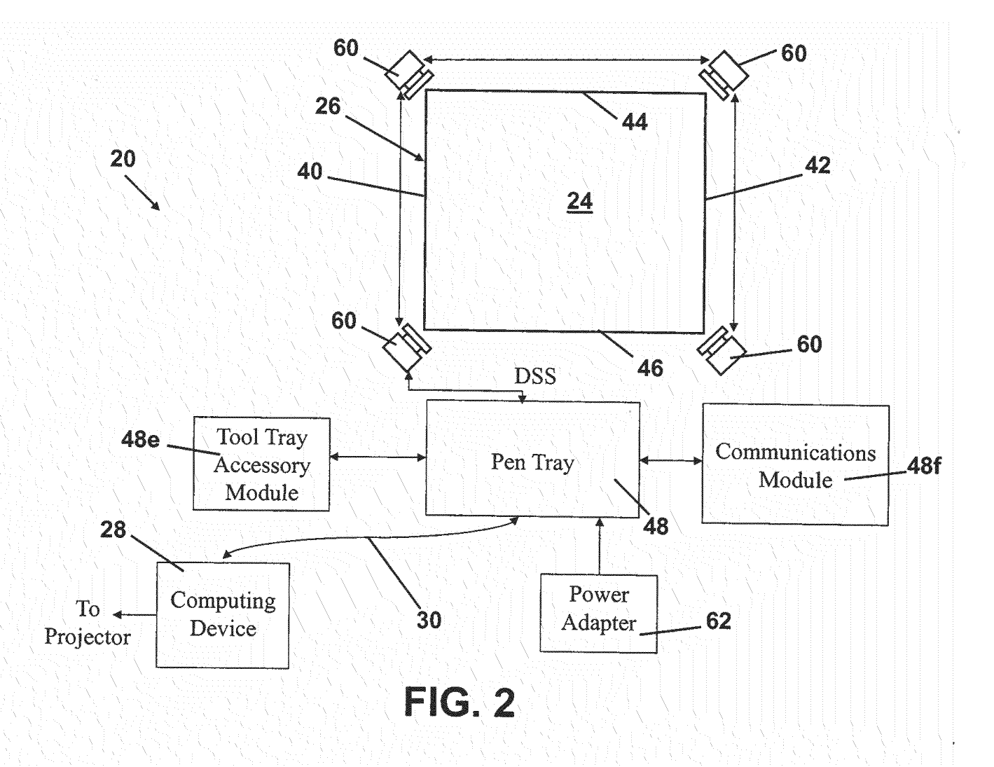

Turning now to FIGS. 1 and 2, an interactive input system that allows a user to inject input such as digital ink, mouse events etc. into an executing application program is shown and is generally identified by reference numeral 20. In this embodiment, interactive input system 20 comprises an interactive board 22 mounted on a vertical support surface such as for example, a wall surface or the like or otherwise supported in a generally upright orientation. Interactive board 22 comprises a generally planar, rectangular interactive surface 24 that is surrounded about its periphery by a bezel 26. An ultra-short throw projector (not shown) such as that sold by SMART Technologies ULC under the name SMART UX60 is also mounted on the support surface above the interactive board 22 and projects an image, such as for example a computer desktop, onto the interactive surface 24.

The interactive board 22 employs machine vision to detect one or more pointers brought into a region of interest in proximity with the interactive surface 24. The interactive board 22 communicates with a general purpose computing device 28 executing one or more application programs via a universal serial bus (USB) cable 30 or other suitable wired or wireless connection. General purpose computing device 28 processes the output of the interactive board 22 and adjusts image data that is output to the projector, if required, so that the image presented on the interactive surface 24 reflects pointer activity. In this manner, the interactive board 22, general purpose computing device 28 and projector allow pointer activity proximate to the interactive surface 24 to be recorded as writing or drawing or used to control execution of one or more application programs executed by the general purpose computing device 28.

The bezel 26 in this embodiment is mechanically fastened to the interactive surface 24 and comprises four bezel segments 40, 42, 44, 46. Bezel segments 40 and 42 extend along opposite side edges of the interactive surface 24 while bezel segments 44 and 46 extend along the top and bottom edges of the interactive surface 24 respectively. In this embodiment, the inwardly facing surface of each bezel segment 40, 42, 44 and 46 comprises a single, longitudinally extending strip or band of retro-reflective material. To take best advantage of the properties of the retro-reflective material, the bezel segments 40, 42, 44 and 46 are oriented so that their inwardly facing surfaces extend in a plane generally normal to the plane of the interactive surface 24.

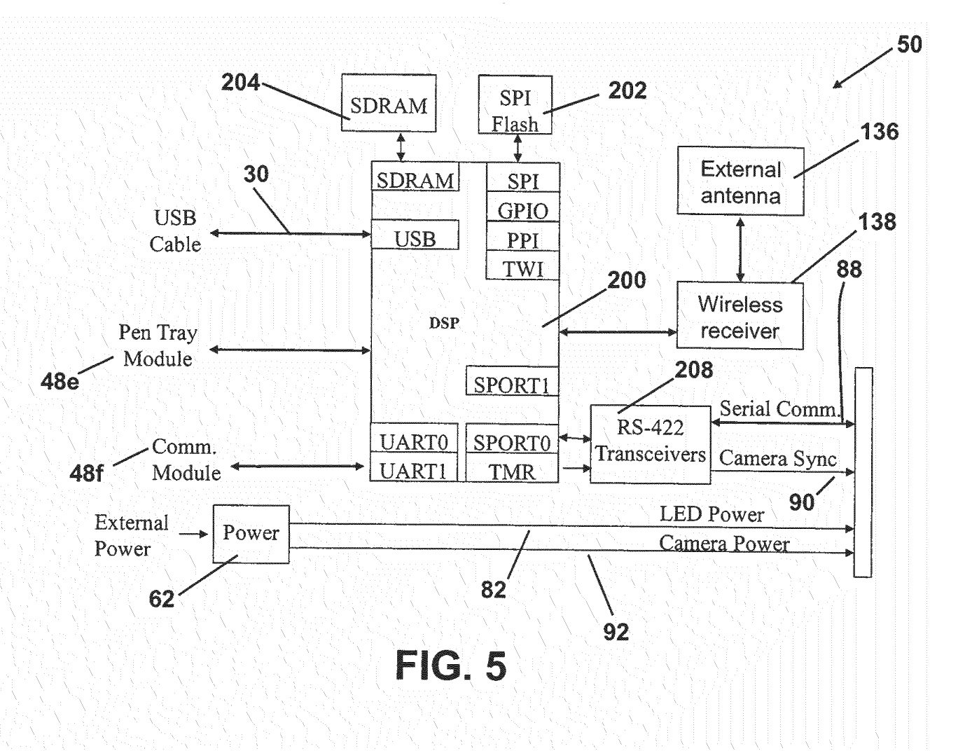

A tool tray 48 is affixed to the interactive board 22 adjacent the bezel segment 46 using suitable fasteners such as for example, screws, clips, adhesive etc. As can be seen, the tool tray 48 comprises a housing 48a having an upper surface 48b configured to define a plurality of receptacles or slots 48c. The receptacles 48c are sized to receive input tools such as pen tools and an eraser tool that can be used to interact with the interactive surface 24. Control buttons 48d are provided on the upper surface 48b to enable a user to control operation of the interactive input system 20. One end of the tool tray 48 is configured to receive a detachable tool tray accessory module 48e while the opposite end of the tool tray 48 is configured to receive a detachable communications module 48f for remote device communications. The housing 48a accommodates a master controller 50 (see FIG. 5) as will be described. Further specifics of the tool tray 48 are described in U.S. Patent Application Publication No. 2011/0169736 to Bolt et al. entitled “Interactive Input System and Pen Tool Tray Therefor” filed on Feb. 19, 2010, the disclosure of which is incorporated herein by reference in its entirety.

Imaging assemblies 60 are accommodated by the bezel 26, with each imaging assembly 60 being positioned adjacent a different corner of the bezel. The imaging assemblies 60 are oriented so that their fields of view overlap and look generally across the entire interactive surface 24. In this manner, any pointer such as for example a user's finger, a cylinder or other suitable object, or a pen or eraser tool lifted from a receptacle 48c of the tool tray 48, that is brought into proximity with the interactive surface 24 appears in the fields of view of the imaging assemblies 60. A power adapter 62 provides the necessary operating power to the interactive board 22 when connected to a conventional AC mains power supply.

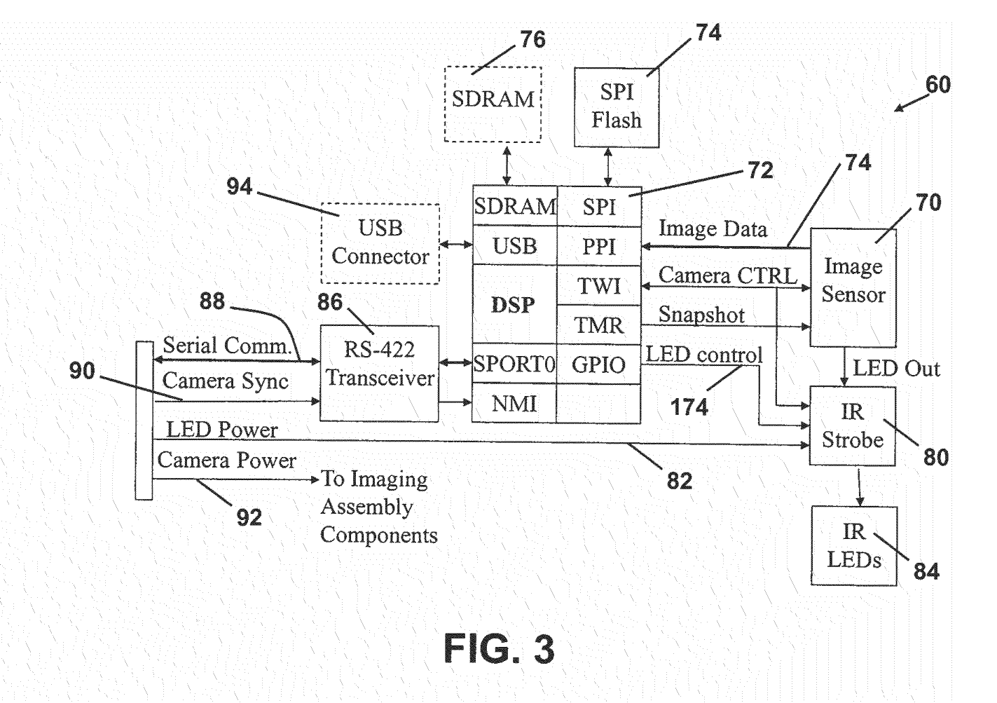

Turning now to FIG. 3, one of the imaging assemblies 60 is better illustrated. As can be seen, the imaging assembly 60 comprises an image sensor 70 such as that manufactured by Aptina (Micron) MT9V034 having a resolution of 752×480 pixels, fitted with a two element, plastic lens (not shown) that provides the image sensor 70 with a field of view of approximately 104 degrees. In this manner, the other imaging assemblies 60 are within the field of view of the image sensor 70 thereby to ensure that the field of view of the image sensor 70 encompasses the entire interactive surface 24.

A digital signal processor (DSP) 72 such as that manufactured by Analog Devices under part number ADSP-BF522 Blackfin or other suitable processing device, communicates with the image sensor 70 over an image data bus 74 via a parallel port interface (PPI). A serial peripheral interface (SPI) flash memory 74 is connected to the DSP 72 via an SPI port and stores the firmware required for image assembly operation. Depending on the size of captured image frames as well as the processing requirements of the DSP 72, the imaging assembly 60 may optionally comprise synchronous dynamic random access memory (SDRAM) 76 to store additional temporary data as shown by the dotted lines. The image sensor 70 also communicates with the DSP 72 via a a two-wire interface (TWI) and a timer (TMR) interface. The control registers of the image sensor 70 are written from the DSP 72 via the TWI in order to configure parameters of the image sensor 70 such as the integration period for the image sensor 70.

In this embodiment, the image sensor 70 operates in snapshot mode. In the snapshot mode, the image sensor 70, in response to an external trigger signal received from the DSP 72 via the TMR interface that has a duration set by a timer on the DSP 72, enters an integration period during which an image frame is captured. Following the integration period after the generation of the trigger signal by the DSP 72 has ended, the image sensor 70 enters a readout period during which time the captured image frame is available. With the image sensor in the readout period, the DSP 72 reads the image frame data acquired by the image sensor 70 over the image data bus 74 via the PPI. The frame rate of the image sensor 70 in this embodiment is between about 900 and about 960 frames per second. The DSP 72 in turn processes image frames received from the image sensor 72 and provides pointer information to the master controller 50 at a reduced rate of approximately 120 points/sec. Those of skill in the art will however appreciate that other frame rates may be employed depending on the desired accuracy of pointer tracking and whether multi-touch and/or active pointer identification is employed.

Strobe circuits 80 communicate with the DSP 72 via the TWI and via a general purpose input/output (GPIO) interface. The strobe circuits 80 also communicate with the image sensor 70 and receive power provided on power line 82 via the power adapter 52. Each strobe circuit 80 drives a respective illumination source in the form of a plurality of infrared (IR) light sources such as IR light emitting diodes (LEDs) 84 that provide infrared backlighting over the interactive surface 24 for the imaging assembly 60 during image capture. Further specifics of the strobe circuits are described in U.S. Patent Application Publication No. 2011/0169727 to Akitt filed on Feb. 19, 2010 and entitled “Interactive Input System Therefor”.

The DSP 72 also communicates with an RS-422 transceiver 86 via a serial port (SPORT) and a non-maskable interrupt (NMI) port. The transceiver 86 communicates with the master controller 50 over a differential synchronous signal (DSS) communication link 88 and a synch line 90. Power for the components of the imaging assembly 60 is provided on power line 92 by the power adapter 52. DSP 72 may also optionally be connected to a USB connector 94 via a USB port as indicated by the dotted lines. The USB connector 94 can be used to connect the imaging assembly 60 to diagnostic equipment.

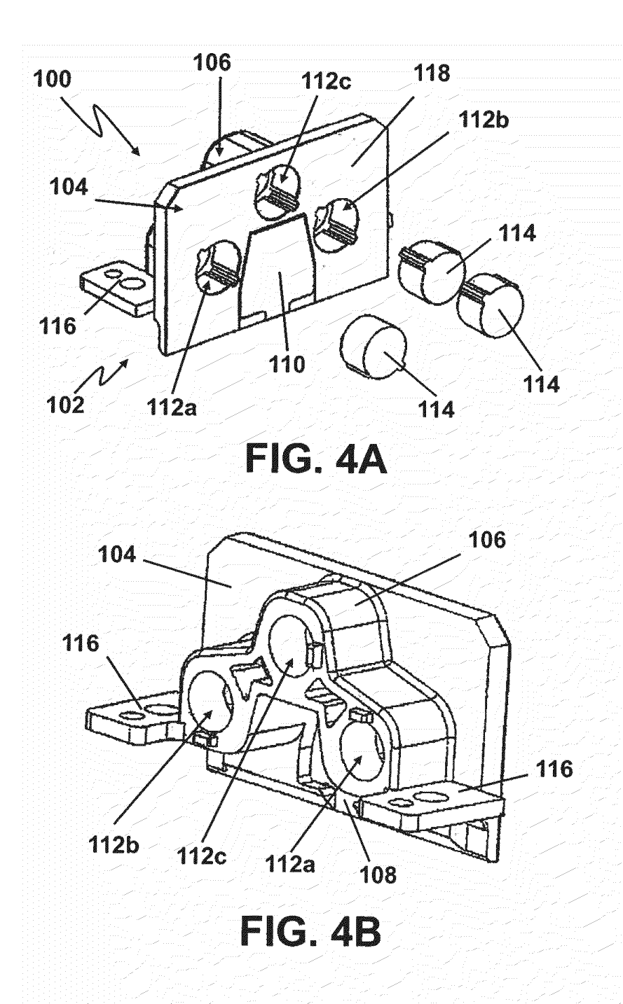

The image sensor 70 and its associated lens as well as the IR LEDs 84 are mounted on a housing assembly 100 that is best illustrated in FIGS. 4A and 4B. As can be seen, the housing assembly 100 comprises a polycarbonate housing body 102 having a front portion 104 and a rear portion 106 extending from the front portion. An imaging aperture 108 is centrally formed in the housing body 102 and accommodates an IR-pass/visible light blocking filter 110. The filter 110 has an IR-pass wavelength range of between about 830 nm and about 880 nm. The image sensor 70 and associated lens are positioned behind the filter 110 and oriented such that the field of view of the image sensor 70 looks through the filter 110 and generally across the interactive surface 24. The rear portion 106 is shaped to surround the image sensor 70. Three tubular passages 112a to 112c are formed through the housing body 102. Passages 112a and 112b are positioned on opposite sides of the filter 110 and are in general horizontal alignment with the image sensor 70. Passage 112c is centrally positioned above the filter 110. Each tubular passage receives a light source socket 114 that is configured to receive a respective one of the IR LEDs 84. Mounting flanges 116 are provided on opposite sides of the rear portion 106 to facilitate connection of the housing assembly 100 to the bezel 26 via suitable fasteners. A label 118 formed of retro-reflective material overlies the front surface of the front portion 104. Further specifics concerning the housing assembly and its method of manufacture are described in U.S. Patent Application Publication No. 2011/0170253 to Liu et al. filed on Feb. 19, 2010 entitled “Housing Assembly for Interactive Input System and Fabrication Method”.

Turning now to FIG. 5, the master controller 50 is better illustrated. As can be seen, master controller 50 comprises a DSP 200 such as that manufactured by Analog Devices under part number ADSP-BF522 Blackfin. A serial peripheral interface (SPI) flash memory 202 is connected to the DSP 200 via an SPI port and stores the firmware required for master controller operation. A synchronous dynamic random access memory (SDRAM) 204 that stores temporary data necessary for system operation is connected to the DSP 200 via an SDRAM port. The DSP 200 communicates with the general purpose computing device 28 over the USB cable 30 via a USB port. The DSP 200 communicates with an external antenna 136 via a wireless receiver 138 and through its serial port (SPORT) with the imaging assemblies 60 via an RS-422 transceiver 208 over the differential synchronous signal (DSS) communication link 88. In this embodiment, as more than one imaging assembly 60 communicates with the DSP 200 of the master controller 50 over the DSS communication link 88, time division multiplexed (TDM) communications is employed. The DSP 200 also communicates with the imaging assemblies 60 via the RS-422 transceiver 208 over the synch line 90. DSP 200 communicates with the tool tray accessory module 48e over an inter-integrated circuit I²C channel and communicates with the communications accessory module 48f over universal asynchronous receiver/transmitter (UART), serial peripheral interface (SPI) and I²C channels.

As will be appreciated, the architectures of the imaging assemblies 60 and the master controller 50 are similar. By employing a similar architecture for both the imaging assemblies 60 and the master controller 50, the same circuit board assembly and common components may be used for both thus reducing the part count and cost of the interactive input system. Differing components are added to the circuit board assemblies during manufacture dependent upon whether the circuit board assembly is intending for use in an imaging assembly 60 or in the master controller 50. For example, the master controller 50 may require a SRAM 76 whereas the imaging assembly 60 may not.

The general purpose computing device 28 in this embodiment is a personal computer or other suitable processing device comprising, for example, a processing unit, system memory (volatile and/or non-volatile memory), other non-removable or removable memory (eg. a hard disk drive, RAM, ROM, EEPROM, CD-ROM, DVD, flash memory, etc.) and a system bus coupling the various computing device components to the processing unit. The general purpose computing device 28 may also comprise a network connection to access shared or remote drives, one or more networked computers, or other networked devices.

During operation, the DSP 200 of the master controller 50 outputs synchronization signals that are applied to the synch line 90 via the transceiver 208. Each synchronization signal applied to the synch line 90 is received by the DSP 72 of each imaging assembly 60 via transceiver 86 and triggers a non-maskable interrupt (NMI) on the DSP 72. In response to the non-maskable interrupt triggered by the synchronization signal, the DSP 72 of each imaging assembly 60 ensures that its local timers are within system tolerances and if not, corrects its local timers to match the master controller 50. Using one local timer, the DSP 72 initiates a pulse sequence via the snapshot line that is used to condition the image sensor to the snapshot mode and to control the integration period and frame rate of the image sensor 70 in the snapshot mode. The DSP 72 also initiates a second local timer that is used to provide output on the LED control line 174 so that the IR LEDs 84 are properly powered during the image frame capture cycle.

In response to the pulse sequence output on the snapshot line, the image sensor 70 of each imaging assembly 60 acquires image frames at the desired image frame rate. In this manner, image frames captured by the image sensor 70 of each imaging assembly 60 can be referenced to the same point of time allowing the position of pointers brought into the fields of view of the image sensors 70 to be accurately triangulated. Each imaging assembly 60 has its own local oscillator (not shown) and synchronization signals are distributed so that a lower frequency synchronization signal (e.g. the point rate, 120 Hz) for each imaging assembly is used to keep image frame capture synchronized. By distributing the synchronization signals for the imaging assemblies 60 rather than transmitting a fast clock signal to each imaging assembly from a central location, electromagnetic interference is reduced.

During image frame capture, the DSP 72 of each imaging assembly 60 also provides output to the strobe circuits 80 to control the switching of the IR LEDs 84. When the IR LEDs 84 are on, the IR LEDs flood the region of interest over the interactive surface 24 with infrared illumination. Infrared illumination that impinges on the retro-reflective bands of bezel segments 40, 42, 44 and 46 and on the retro-reflective labels 118 of the housing assemblies 100 is returned to the imaging assemblies 60. As a result, in the absence of a pointer, the image sensor 70 of each imaging assembly 60 sees a bright band having a substantially even intensity over its length together with any ambient light artifacts. When a pointer is brought into proximity with the interactive surface 24, the pointer occludes infrared illumination reflected by the retro-reflective bands of bezel segments 40, 42, 44 and 46 and/or the retro-reflective labels 118. As a result, the image sensor 70 of each imaging assembly 60 sees a dark region that interrupts the bright band in captured image frames. The reflections of the illuminated retro-reflective bands of bezel segments 40, 42, 44 and 46 and the illuminated retro-reflective labels 118 appearing on the interactive surface 24 are also visible to the image sensor 70.

The sequence of image frames captured by the image sensor 70 of each imaging assembly 60 is processed by the associated DSP 72 to remove ambient light artifacts and to identify each pointer in each image frame. The DSP 72 of each imaging assembly 60 in turn conveys the pointer data to the DSP 200 of the master controller 50. The DSP 200 uses the pointer data received from the DSPs 72 to calculate the position of each pointer relative to the interactive surface 24 in (x,y) coordinates using well known triangulation as described in above-incorporated U.S. Pat. No. 6,803,906 to Morrison. This pointer coordinate data together with pen tool operating mode information received by the DSP 200 from one or more pen tools via the external antenna 136 and wireless receiver 138, if any, are conveyed to the general purpose computing device 28 allowing the image data presented on the interactive surface 24 to be updated.

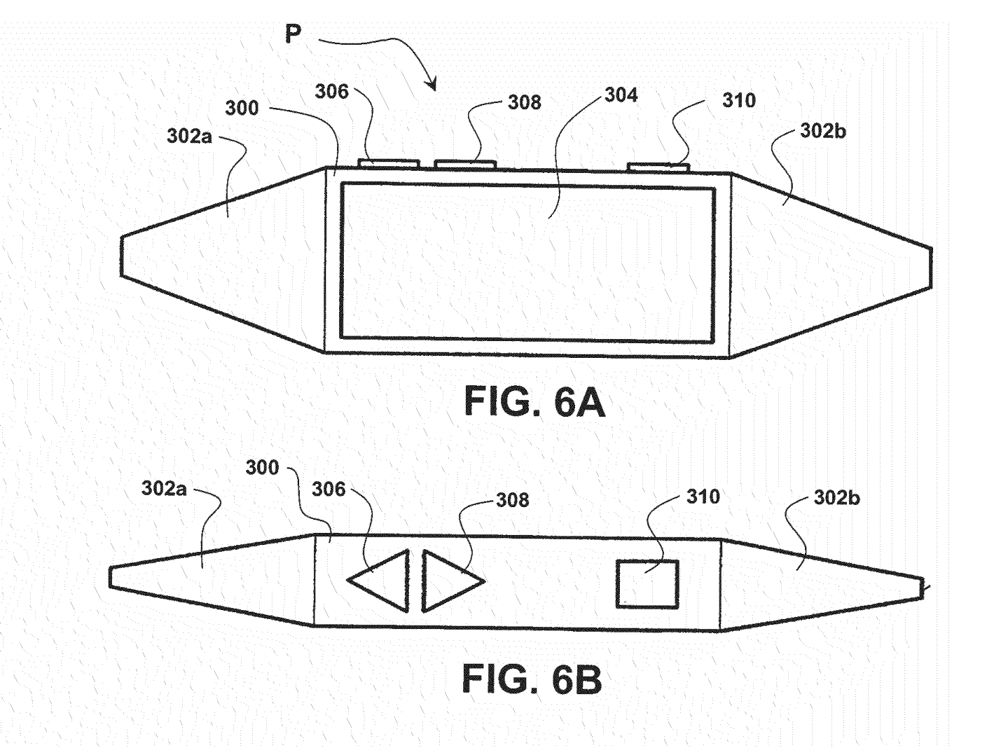

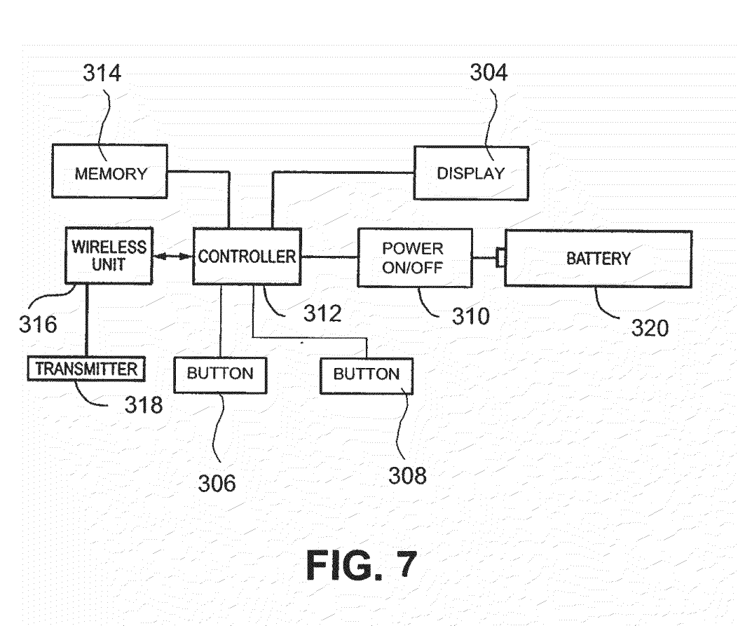

Turning now to FIGS. 6A, 6B and 7, a pen tool P for use with the interactive input system 20 is shown. In this embodiment, the pen tool P can be conditioned to one of a plurality of selectable operating modes as will be described. The pen tool P comprises a body 300 formed by interconnected half shells that has conical tips 302a and 302b at its opposite ends. A display 304, which in this embodiment is a color liquid crystal display (LCD) that is capable of displaying textual and graphical information in a range of colors, is provided on the body 300 intermediate its ends. The display 304 is configured to display information associated with the currently active operating mode of the pen tool P. The selectable operating modes of the pen tool P are grouped into operating mode categories. A plurality of buttons are also provided on the body 300. In this embodiment, the buttons include a pair of buttons 306 and 308, which may be depressed to allow a user to select an operating mode category and an operating mode within the selected operating mode category as well as a power on/off button 310, which may be depressed to allow the user to power the pen tool P on and off.

The interior of the body 300 houses processing circuitry mounted on a printed circuit board. In this embodiment, the processing circuitry comprises a controller 312 that communicates with a wireless unit 316. Wireless unit 316 is conditioned by the controller 312 to broadcast a modulated signal via a wireless transmitter 318, such as for example, a radio frequency (RF) antennae or one or more illumination sources, such as IR LEDs, when the pen tool P is powered on through actuation of button 310. The signal broadcast by the pen tool P is modulated by operating mode information that identifies the currently selected operating mode of the pen tool P. The controller 312 also communicates with memory 314 that stores information associated with the pen tool operating modes. In this embodiment, the memory 314 stores, for each selectable pen tool operating mode, its operating mode category, a graphical image icon of the pen tool operating mode, and the operating mode information that is used to modulate the signal broadcast by the pen tool P. The graphical image icon generally corresponds to an appearance of digital ink associated with the pen tool operating mode. A battery 320 supplies power to the processing circuitry.

With the pen tool P powered on, when a user depresses button 306, the controller 312 cycles through the operating mode categories stored in the memory 314, and in turn displays the name of each operating mode category on the display 304 in succession. In this manner, the user can press the button 306 until the desired pen tool operating mode category appears on the display 304 thereby to select that pen tool operating mode category. Once a pen tool operating mode category has been selected, when the user depresses button 308, the controller 312 cycles through the pen tool operating modes of the selected operating mode category, and in turn displays a graphical image representation of those pen tool operating modes on the display 304 in succession.

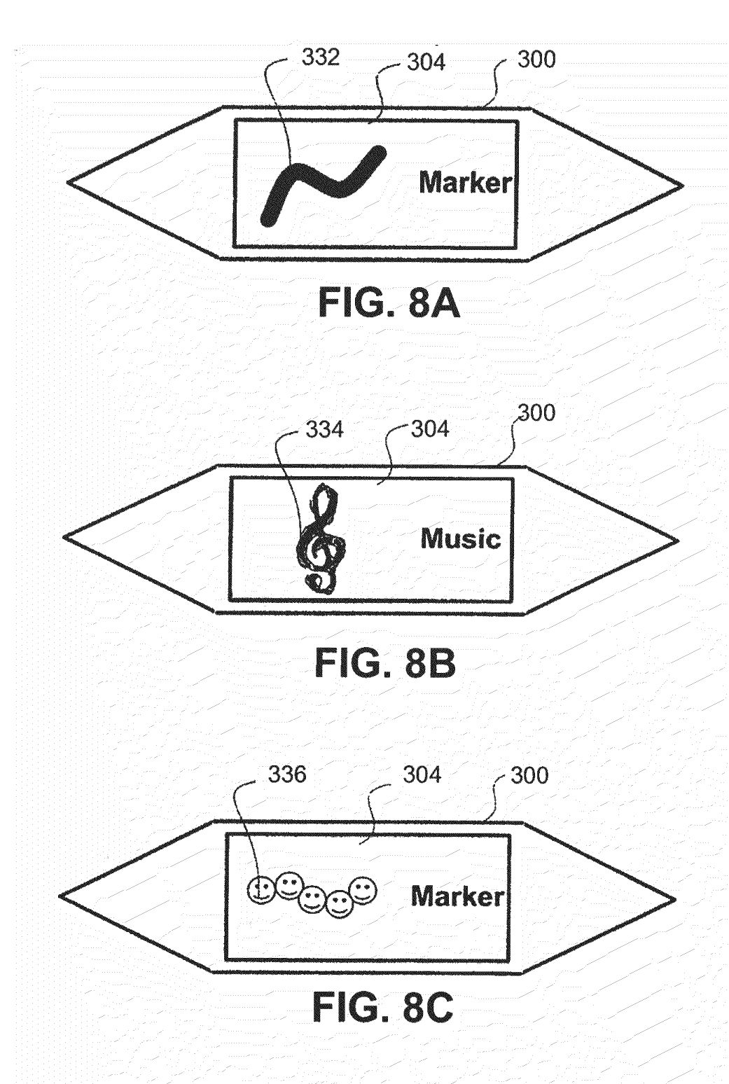

FIGS. 8A to 8C show examples of pen tool operating mode information displayed on the display 304 of the pen tool P. In the example shown in FIG. 8A, the selected pen tool operating mode is a marker-line operating mode forming part of a marker operating mode category. As a result, the name “Marker” is displayed on the display 304 in a text field, and a graphical image representative of the selected pen tool operating mode is displayed on the display 304 as a line icon 332. In the example shown in FIG. 8B, the selected pen tool operating mode is a music-treble clef operating mode forming part of a music operating mode category. As a result, the name “Music” is displayed on the display 304 in the text field, and a graphical image representative of the selected pen tool operating mode is displayed on the display 304 as a treble clef icon 334. In the example shown in FIG. 8C, the selected pen tool operating mode is a marker-happy face operating mode also forming part of the marker operating mode category. As a result, the name “Marker” is displayed on the display 304 in the text field, and a graphical image representative of the selected pen tool operating mode is displayed on the display 304 as a happy face chain icon 336.

Once a threshold time period has passed after button 306 and/or button 308 has been depressed resulting in an operating mode category and a pen tool operating mode thereof being selected, in this embodiment one (1) second, the controller 312 conditions the wireless unit 316 to continuously broadcast a signal modulated with the operating mode information associated with the selected pen tool operating mode. Of course, a different threshold time period may be employed or the wireless unit may be configured to broadcast automatically a modulated signal upon powering up of the pen tool P. In this latter case, the signal may be broadcast with the last selected pen tool operating mode or a default pen tool operating mode being used to modulate the broadcast signal.

The DSP 200 stores a modulated signal-to-pen tool operating mode mapping table in the memory 202. When the pen tool P is brought into proximity with the interactive surface 24 and a broadcast modulated signal is received by the DSP 200 via the antenna 136 and wireless receiver 138, the DSP 200 compares the received modulated signal to the mapping table to determine the pen tool operating mode. The DSP 200 in turn uses this information to assign mode information to the generated pointer coordinates, and conveys the mode information along with the pointer coordinates to the general purpose computing device 28 so that the pointer coordinates are processed by the general purpose computing device 28 in the desired manner. The general purpose computing device 28 treats the pointer coordinates as either marker (i.e. ink) events, eraser events, mouse events, or other events, in accordance with the mode information.

Although in the embodiment described above, the pen tool P comprises a color LCD that is capable of displaying textual and graphical information in a range of colors, in other embodiments, the pen tool may alternatively comprise another type of display. For example, in other embodiments, the pen tool may comprise a monochromatic LCD, a single-line or multi-line display that is capable of displaying only alphanumeric information, and/or other types of displays that are capable of displaying alphanumeric information and/or graphical information.

Although in the embodiment described above, the pen tool comprises buttons which may be depressed for selecting the operating mode category and the operating mode of the pen tool, in other embodiments, the pen tool may comprise other configurations. For example, the pen tool may comprise one or more switches capable of being toggled through multiple positions, one or more rotating switches, one or more scroll wheels, and/or one or more pressure or orientation sensitive switches etc., actuable to allow the operating mode category and operating mode of the pen tool P to be selected. In other embodiments, the pen tool may further comprise a microphone and the controller may be configured to execute voice recognition software to enable the operating mode category and pen tool operating mode to be selected by the user by voice command input into the microphone. In still other embodiments, the operating mode category and operating mode of the pen tool may also be selected through haptic commands, such as through pointer input on the interactive surface 24. In a related embodiment, the display of the pen tool may be touch sensitive, and may be configured to receive touch input for selection of the operating mode category and operating mode of the pen tool.

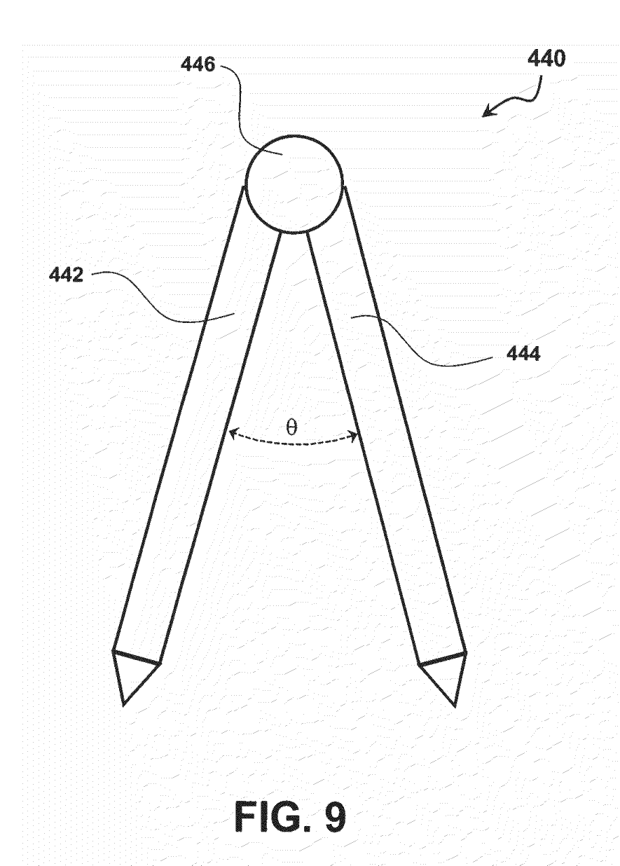

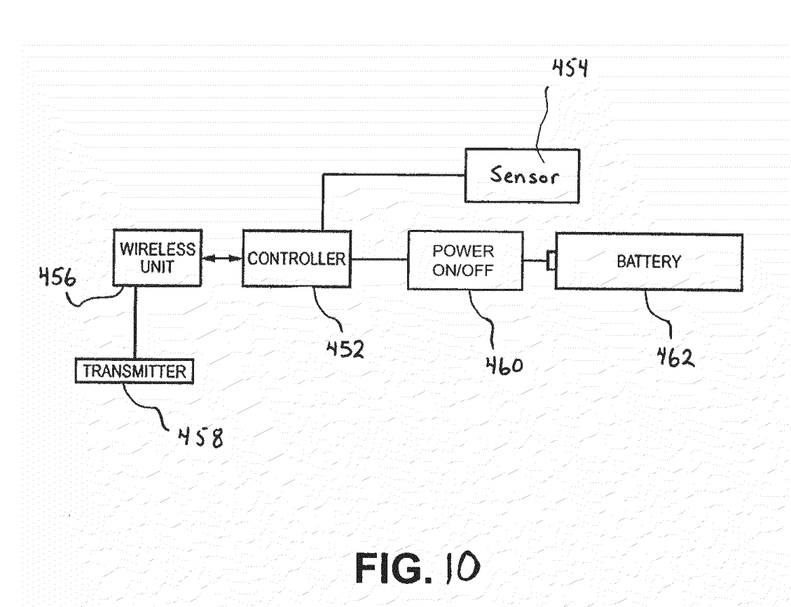

FIGS. 9 and 10 show another embodiment of an input tool in the form of a compass for use with the interactive input system 20, and which is generally indicated using reference numeral 440. Compass 440 comprises a first arm 442 and a second arm 444 that are pivotally connected to each other by a hinge 446. The first and second arms 442 and 444 may be rotated relative to each other about the hinge 446 to vary the angle θ formed by the arms 442 and 444. In this embodiment, the value of the angle θ may range from 0 degrees to 180 degrees.

The compass 440 comprises processing circuitry mounted on a printed circuit board (not shown) that is housed within the first arm 442. The processing circuitry comprises a controller 452 that communicates with a sensor in the form of a potentiometer 454 housed within the hinge 446. The potentiometer 454 is configured to provide output proportional to the angle θ formed by the arms 442 and 444 to the controller 452. The controller 452 also communicates with a wireless unit 456. Wireless unit 456 is conditioned by the controller 452 to broadcast a modulated signal via wireless transmitter 458 when the compass 440 is powered on via power on/off switch 460 located on arm 442 and battery 462. The broadcast signal is modulated by angle information that identifies the relative orientation of the arms 442 and 444.

In this embodiment, the DSP 200 stores a modulated signal-to-compass operating mode mapping table in the memory 202. When the compass 440 is brought into proximity with the interactive surface 24 and a broadcast modulated signal is received by the DSP 200 via the antenna 136 and wireless receiver 138, the DSP 200 compares the received modulated signal to the mapping table to determine the compass operating mode. The DSP 200 in turn uses this information to assign mode information to the generated pointer coordinates and conveys the mode information along with the pointer coordinates to the general purpose computing device 28 so that the pointer coordinates are processed by the general purpose computing device 28 in the desired manner.

In this embodiment, when the compass 440 is fully closed and the angle θ between first and second arms 442 and 444 is substantially equal to zero (0) degrees, the DSP 200 assigns geometric correction mode information to the generated pointer coordinates. In this mode, the general purpose computing device 28 geometrically corrects digital ink displayed at locations corresponding to the pointer coordinates. The geometrical corrections may comprise, for example, straightening lines that are not straight, and rendering non-true geometric objects (e.g. triangles, rectangles, pentagons, etc.) true. When the compass 440 is fully open and the angle θ between first and second arms 442 and 444 is equal to approximately 180 degrees, the DSP 200 assigns orthogonal ink mode information to the generated pointer coordinates. In this mode, the general purpose computing device 28 generates digital ink in the form of either vertical or horizontal lines, only, at the generated pointer coordinates. When the compass 440 is partially open and the angle θ between first and second arms 442 and 444 is between zero and 180 degrees, the DSP 200 assigns compass ink mode information to the generated pointer coordinates. In this mode, the general purpose computing device 28 generates digital ink in the form of generally perfect arcs or circular lines at the generated pointer coordinates.

If desired, a display may be provided on one or both of the arms for displaying the current compass operating mode. Similar to the previous embodiment, the display may be a colour or monochromatic LCD, a single or multi-line display or other suitable display.

Although specific input tool operating modes and operating mode categories have been described, those of skill in the art will appreciate that many other input tool operating modes and categories may be assigned.

Although in embodiments described above, the DSP 200 is shown as comprising an antenna and a wireless receiver for receiving the modulated signal output by the input tool, in other embodiments, each imaging assembly may alternatively be provided with an antenna and a wireless receiver for receiving the modulated signal output by the input tool. In other embodiments, the input tool may alternatively be tethered to the interactive board or to the DSP of the master controller for allowing the modulated signal output by the input tool to be conveyed by a wired connection.

In other embodiments, the input tool may alternatively comprise one or more tip switch assemblies, each of which is actuable when brought into contact with the interactive surface. In these embodiments, the controller conditions the wireless unit and transmitter to broadcast the modulated signal upon actuation of a tip switch assembly.

In other embodiments, the modulated signal that is broadcast by the input tool may also comprise a unique identifier of the input tool that allows the input tool to be distinguished from other input tools and/or other pointers by the interactive input system.

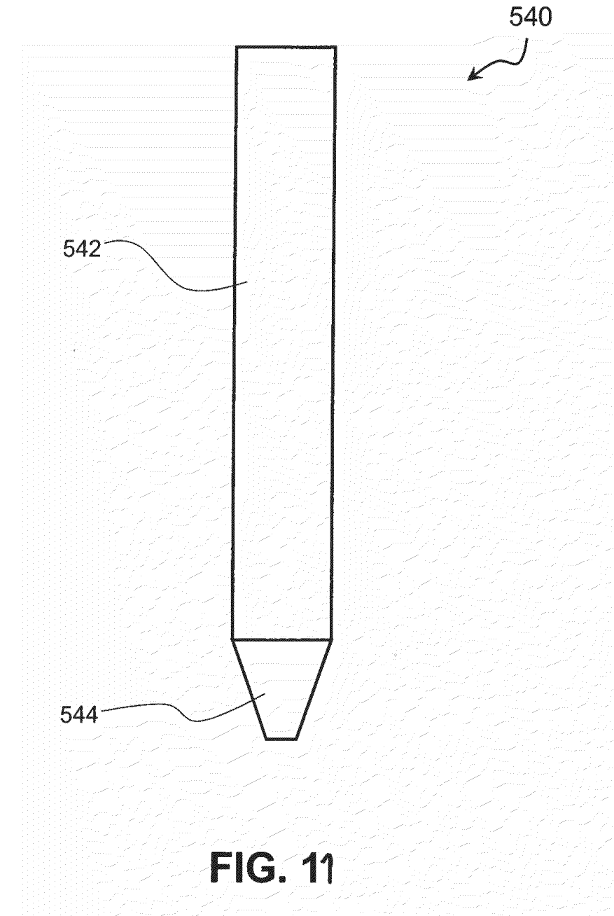

It will also be appreciated that other forms of input tools may be used with the interactive input system 20. For example, FIG. 11 shows a pen tool or stylus for use with the interactive input system 20, and which is generally indicated by reference numeral 540. Stylus 540 comprises an elongate cylindrical body 542 having a generally conical, deformable nib 544 at one end thereof. The deformable nib 544 is fabricated of a resilient, compressible material, such that the profile of nib 544 compresses in response to pressure applied to the stylus 540 during use. The deformable nib 544 has a low-friction surface, which allows the stylus 540 to be easily moved across the interactive surface 24 during use at different amounts of applied pressure without damaging the interactive surface 24 and without causing offensive noise. In this embodiment, the deformable nib 544 is fabricated of visco-elastic polyurethane foam that is coated with a polytetrafluoroethylene (PTFE)-based material.

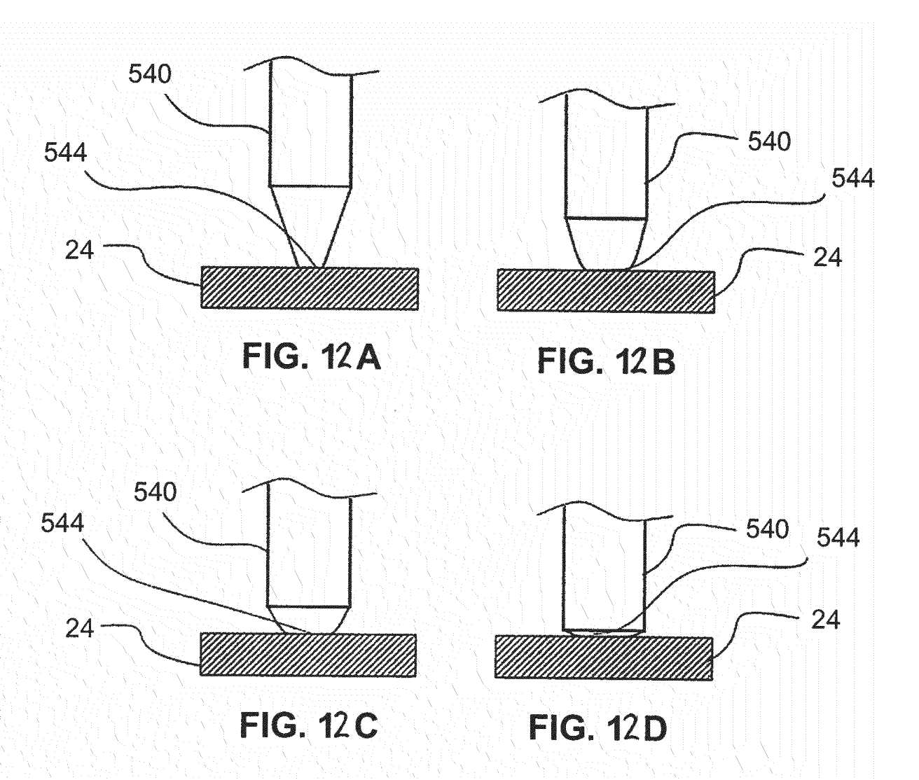

FIGS. 12A to 12D show the deformable nib 544 of the stylus 540 deforming in response to different amounts of applied pressure to the interactive surface 24. When very light or no pressure is applied to the interactive surface by the stylus 540, the deformable nib 544 maintains its original conical shape, as shown in FIG. 12A. As the pressure applied by the stylus 540 to the interactive surface 24 is increased to light pressure, to medium pressure and to heavy pressure, as shown in FIGS. 12B to 12D respectively, the deformable nib 544 responds by compressing proportionately. As a result, the contact area between the deformable nib 544 and the interactive surface 24 increases. Also, the shape of the deformable nib 544 when viewed from the side becomes less conical and more cylindrical as the applied pressure increases.

During operation, the DSP 200 uses the pointer tip shape, received from the DSPs 72 with the pointer data, to determine the tip pressure applied to the interactive surface 24 by the stylus 540. The calculated pointer coordinates and the tip pressure are then conveyed by the DSP 200 to the general purpose computing device 28 via the USB cable 30. The general purpose computing device 28 in turn processes the received pointer coordinates and tip pressure data, and updates the image output provided to the display unit, if required, so that the image presented on the interactive surface 24 reflects the pointer activity.

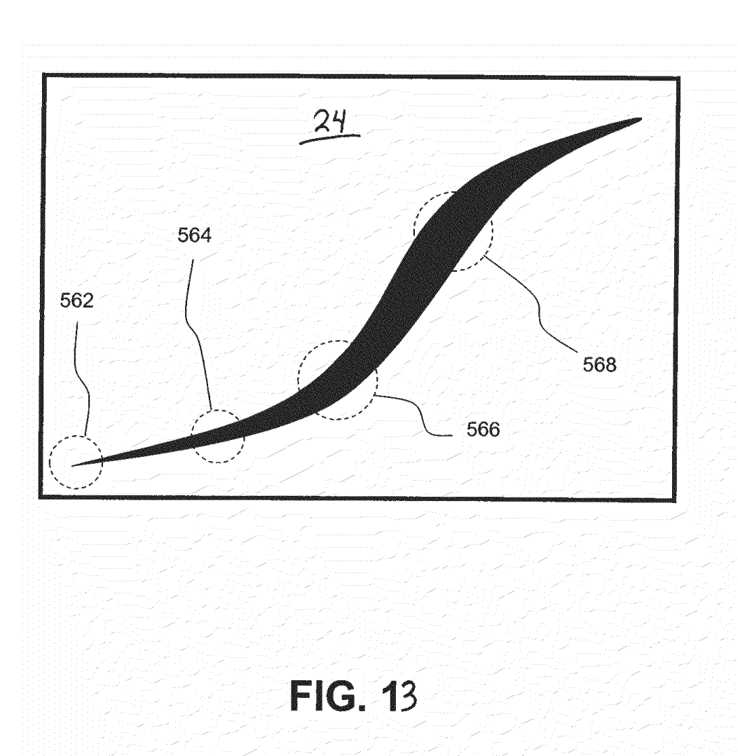

FIG. 13 schematically shows digital ink displayed on the interactive surface 24 resulting from movement of the stylus 540 across the interactive surface 24. During the movement, the pressure applied to the interactive surface 24 by the stylus 540 varies from very light pressure, to light pressure, to medium pressure and to heavy pressure. In response, the thickness of the digital ink appearing on the interactive surface 24 varies from very fine digital ink 562, to fine digital ink 564, to medium digital ink 56 and to thick digital ink 568, respectively.

Although in the embodiments described above, the imaging assemblies 60 are described as being positioned adjacent corners of the bezel, those of skill in the art will appreciate that the imaging assemblies may be placed at different locations relative to the bezel.

Those of skill in the art will also appreciate that, although the operation of the interactive input system 20 has been generally described with reference to a single input tool being positioned in proximity with the interactive surface, the interactive input system 20 is capable of detecting multiple input tools that are positioned in proximity with the interactive surface.

Although preferred embodiments have been described, those of skill in the art will appreciate that variations and modifications may be made with departing from the scope thereof as defined by the appended claims.

What is claimed is:

1. An input tool for use with an interactive input system, the input tool comprising:
a body housing processing circuitry storing input tool operating mode data representing operating modes of said input tool; and
at least one display on the body and communicating with said processing circuitry, said display being responsive to said processing circuitry to present a selected operating mode of said input tool.

2. The input tool of claim 1 wherein the processing circuitry is responsive to user input to select one of said input tool operating modes for presentation on said display.

3. The input tool of claim 2 wherein the input tool operating modes are grouped into categories and wherein the operating modes of a user selected category are selectable for presentation on said display.

4. The input tool of claim 2 further comprising at least one manually actuable element on said housing, said processing circuitry being responsive to actuation of said at least one element to enable user selection of an input tool operating mode.

5. The input tool of claim 3 further comprising at least one manually actuable element on said housing, said processing circuitry being responsive to actuation of said at least one element to enable user selection of an input tool operating mode.

6. The input tool of claim 1 wherein said processing circuitry wirelessly broadcasts said selected input tool operating mode.

7. The input tool of claim 6 wherein said selected input tool operating mode is used to modulate a signal broadcast by said processing circuitry.

8. The input tool of claim 7 wherein the processing circuitry is responsive to user input to select one of said input tool operating modes for presentation on said display.

9. The input tool of claim 8 wherein the input tool operating modes are grouped into categories and wherein the operating modes of a user selected category are selectable for presentation on said display.

10. The input tool of claim 7 further comprising at least one manually actuable element on said housing, said processing circuitry being responsive to actuation of said at least one element to enable user selection of an input tool operating mode.

11. The input tool of claim 1 wherein said display is a color display.

12. The input tool of claim 11 wherein said display is configured to display textual and graphical information.

13. The input tool of claim 1 wherein said display presents a graphical image icon of the selected input tool operating mode.

14. The input tool of claim 13 wherein said graphical image icon generally corresponds to an appearance of digital ink associated with the selected input tool operating mode.

15. The input tool of claim 12 wherein the processing circuitry is responsive to user input to select one of said input tool operating modes for presentation on said display.

16. The input tool of claim 15 wherein the input tool operating modes are grouped into categories and wherein the operating modes of a user selected category are selectable for presentation on said display.

17. The input tool of claim 15 further comprising at least one manually actuable element on said housing, said processing circuitry being responsive to actuation of said at least one element to enable user selection of an input tool operating mode.

18. An input tool for use with an interactive input system, the input tool comprising:
a pair of arms rotatably connected together by a hinge;
a sensor providing output representing the angle formed between said arms; and
processing circuitry communicating with said sensor and outputting a signal comprising angle information.

19. The input tool of claim 18, wherein said sensor comprises a potentiometer.

20. The input tool of claim 18 wherein said processing circuitry wirelessly broadcasts said signal.

21. The input tool of claim 20 wherein said angle information is used to modulate said broadcast signal.

22. An input tool for use with an interactive input system, the input tool comprising:
an elongate body; and
a deformable nib at one end of said body configured to contact an interactive surface.

23. The input tool of claim 22 wherein said deformable nib is generally conical and wherein the shape of said deformable nib becomes less conical and more cylindrical as pressure applied to said interactive surface by said deformable nib increases.

24. The input tool of claim 23 wherein said deformable nib is fabricated of visco-elastic polyurethane foam.

25. The input tool of claim 24 wherein said deformable nib comprises a low-friction surface.

26. The input tool of claim 24 wherein said visco-elastic polyurethane foam is coated with a polytetrafluoroethylene-based material.

27. An interactive input system comprising:
at least one imaging assembly capturing image frames of a region of interest; and
processing structure communicating with said at least one imaging assembly and processing said captured image frames to:
determine the shape of an input tool tip appearing therein; and
generate tip pressure data based on the determined shape of said input tool tip.

28. The interactive input system of claim 27 wherein said processing structure is configured to use said tip pressure data to modify a displayed image.

29. The interactive input system of claim 28 wherein said processing structure is configured to modify the appearance of displayed digital ink.

30. The interactive input system of claim 29 wherein said processing structure is configured to adjust the thickness of displayed digital ink dependent on said tip pressure data.
